(19) United States
(12) Patent Application Publication
(10) Pub. No.: US 2012/0223090 A1
(43) Pub. Date: Sep. 6, 2012

(54) Rear-Loading Product Dispensing System and Method

(76) Inventors: Laurel Thomas, Richmond, VA (US); David Hayslette, Midlothian, VA (US)

(21) Appl. No.: 13/039,667

(22) Filed: Mar. 3, 2011

(51) Int. Cl. B65D 83/00; B65G 59/00

(52) U.S. Cl. 221/1; 221/31

(57) ABSTRACT

A product dispensing system including a container, a plurality of products initially housed in the container and a dispenser, the dispenser including a frame and an opening tool, the frame having a front end and a rear end, and including a support deck and a product display area, the support deck extending between the front end and the rear end, the product display area being positioned below the support deck proximate the front end, the opening tool being positioned to open the container and allow at least one of the products to move from the container to the product display area as the container is moved along the support deck from the rear end toward the front end.

### FIELD

This application relates to the dispensing of products from packaging containers and, more particularly, to packaging containers configured to cooperate with product dispensers to dispense products.

### BACKGROUND

Products are typically shipped to retailers in bulk by enclosing multiple individual product units in a container, such as a carton or box. For example, canned foods may be shipped to a retailer in a box containing twenty-four individual cans. Then, it is typically the retailer's obligation to remove the individual product units from the container and present them (e.g., on a shelf) to consumers.

Alternatives to the traditional package-ship-unpack-display model are being developed in an effort to improve operating efficiency. For example, U.S. patent application Ser. No. 12/777,444 filed on May 11, 2010, the entire contents of which are incorporated herein by reference, discloses a new system for dispensing and displaying products packaged in a container. Specifically, the product dispensing system includes a dispenser having a support structure, a product display area and an opening tool. The dispenser may be positioned on a retailer's shelf and loaded with product simply by placing a container comprising multiple units of product onto the support structure of the dispenser. As the container is being placed onto the support structure, the opening tool of the dispenser opens the container in such a manner that product rolls from the container and down to the product display area of the dispenser under the force of gravity.

Despite advances in the field, those skilled in the art continue with research and development efforts directed to apparatus and systems for dispensing products from packaging containers.

### SUMMARY

In one aspect, the disclosed product dispensing system may include a container, a plurality of products initially housed in the container and a dispenser, the dispenser may include a frame and an opening tool, the frame may have a front end and a rear end, and may include a support deck and a product display area, the support deck may extend between the front end and the rear end, the product display area may be positioned below the support deck proximate the front end, the opening tool may be positioned to open the container and allow at least one of the products to move from the container to the product display area as the container is moved along the support deck from the rear end toward the front end.

In another aspect, the disclosed product dispensing system may include (1) a container having a plurality of walls that define an internal volume, at least one of the walls of the container including a pre-formed pivot line and a severance line that at least partially define an access panel, (2) a plurality of products initially received in the internal volume of the container, and (3) a dispenser including a frame having a front end and a rear end, the frame including a support deck and a product display area, the support deck extending between the front end and the rear end of the frame, the product display area being positioned below the support deck proximate the front end of the frame, and an opening tool positioned to sever the severance line as the container is moved along the support deck from the rear end toward the front end so as to allow the access panel to pivot about the pre-formed pivot line and release at least one product from the container to the product display area.

In yet another aspect, the disclosed product dispensing method may include the steps of (1) providing a container housing a plurality of products, the container including a severance line and a pre-formed pivot line that at least partially define an access panel, (2) providing a dispenser frame having a front end and a rear end, the dispenser frame including a support deck and a product display area, the support deck extending between the front end and the rear end of the frame, the product display area being positioned below the support deck proximate the front end of the frame, (3) providing an opening tool associated with said frame and (4) sliding the container relative to the opening tool along the support deck from the rear end to the front end such that the opening tool severs the severance line to allow the access panel to pivot about the pre-formed pivot line and allow at least one product to be dispensed from the container to the product display area.

Other aspects of the disclosed rear-loading product dispensing system and method will become apparent from the following detailed description, the accompanying drawings and the appended claims.

### BRIEF DESCRIPTION OF THE DRAWINGS

FIG. 1 is a front and side perspective view of one aspect of the disclosed rear-loading product dispensing system;

FIG. 2 is a front and bottom perspective view of the container of the product dispensing system of FIG. 1;

FIG. 3 is rear and side perspective view of the container of FIG. 2;

FIG. 4 is rear and side perspective view of the container of FIG. 3, shown in an open configuration;

FIG. 5 is a top plan view of a container blank useful for forming the container of FIG. 2;

FIG. 6 is a side elevational view, in section, of the product dispensing system of FIG. 1; and

FIG. 7 is a top plan view of the dispenser of the product dispensing system of FIG. 6.

### DETAILED DESCRIPTION

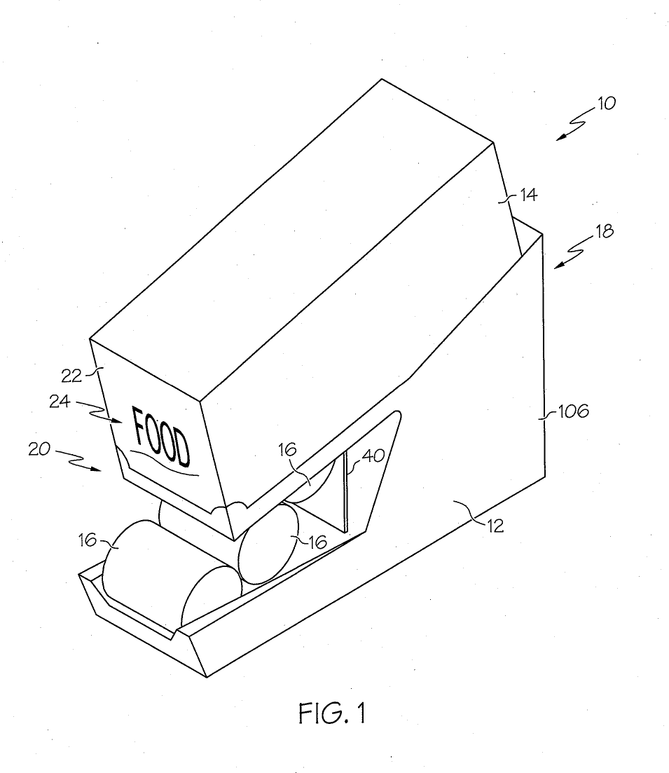

Referring to FIG. 1, one aspect of the disclosed rear-loading product dispensing system, generally designated 10, may include a dispenser 12 and a container 14. The container 14 may house multiple units of product 16, such as cans (e.g., canned food), jars (e.g., jarred sauce) or bottles (e.g., bottled soft drinks). Each product 16 may be configured to roll about a rolling axis. The dispenser 12 may open the container 14 and release the products 16 from the container 14 to the dispenser 12 as the container 14 is urged from the rear end 18 of the dispenser 12 toward the front end 20 of the dispenser 12.

The container 14 may be any container capable of housing products 16 and beneficially interacting with the disclosed dispenser 12 to release the products 16 to the dispenser 12. For example, the container 14 may be a paperboard carton or a corrugated box. Optionally, at least one major surface 22 of the container 14 may be marked with various indicia 24, such as printed text and/or graphics.

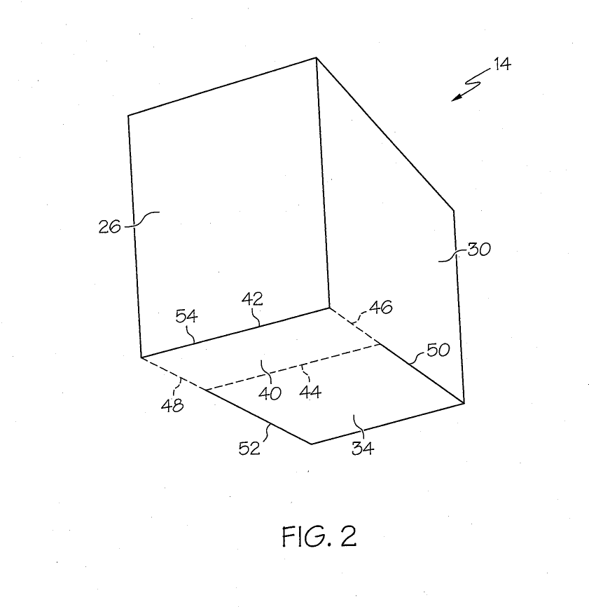

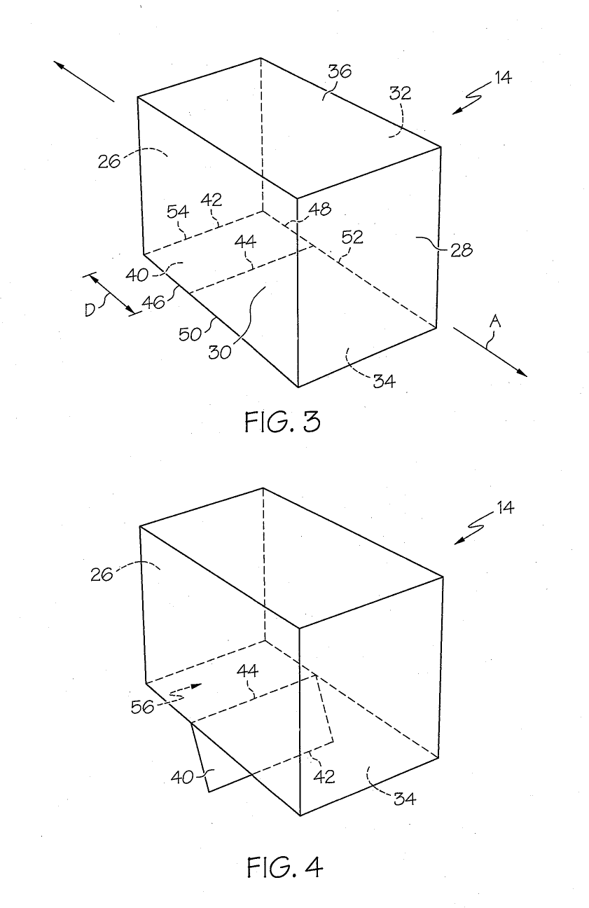

As shown in FIGS. 2 and 3, in one particular construction, the container 14 may be a generally rectilinear container having six walls 26, 28, 30, 32, 34, 36. Opposed walls 26 and 28 may define the front and rear walls, respectively, of the container 14. Opposed walls 30 and 32 may extend along the longitudinal axis A (FIG. 3) of the container 12, and may define the first (e.g., right) and second (e.g., left) side walls, respectively, of the container 14. Opposed walls 34 and 36 may extend along the longitudinal axis A of the container 12, and may define the base and upper walls, respectively, of the container 14.

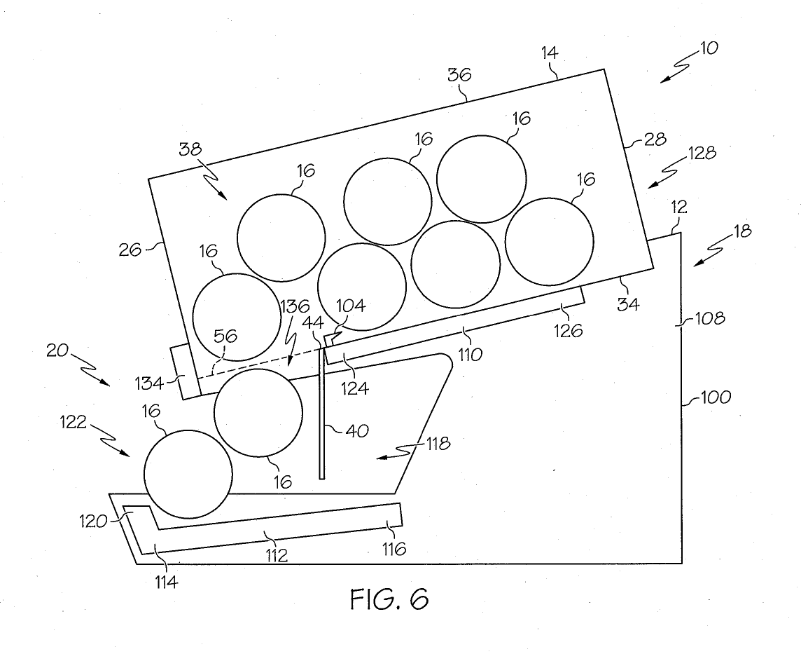

As shown in FIG. 6, the walls 26, 28, 30, 32, 34, 36 of the container 14 may define an internal volume 38 for receiving the products 16. The overall size and shape of the internal volume 38 of the container 14 may be sufficient to allow the products 16 to roll along the base wall 34 when the container 14 is loaded onto the dispenser 12.

Referring back to FIGS. 2 and 3, the base wall 34 of the container 14 may define an access panel 40 that is openable to release the products 16 from the container 14. The access panel 40 may be defined by a forward edge 42, a pre-formed pivot line 44, a first severance line 46 and a second severance line 48.

The pre-formed pivot line 44 may laterally extend across the base wall 34 of the container 14 from proximate (i.e., at or near) the right side wall 30 to proximate the left side wall 32. The distance D between the pre-formed pivot line 44 and the forward edge 42 may define the longitudinal length of the access panel 40, and may be greater than the greatest diameter of the products 16 housed in the container 14.

The pre-formed pivot line 44 may be formed by weakening the container 14 along the pre-formed pivot line 44. Examples of weakening techniques useful in forming the pre-formed pivot line 44 include scoring the container 14, forming a crease in the container 14 and forming perforations in the container 14.

The first severance line 46 may longitudinally extend from the forward edge 42 to the pre-formed pivot line 44. For example, the first severance line 46 may extend from the forward edge 42 to the pre-formed pivot line 44 proximate the edge 50 between the base wall 34 and the right side wall 30.

The second severance line 48 may longitudinally extend from the forward edge 42 to the pre-formed pivot line 44. For example, the second severance line 48 may extend from the forward edge 42 to the pre-formed pivot line 44 proximate the edge 52 between the base wall 34 and the left side wall 32.

The first and second severance lines 46, 48 may be weakened to make it easier to sever the first and second severance lines 46, 48. However, the first and second severance lines 46, 48 may have sufficient strength such that the first and second severance lines 46, 48 are not severed merely due to the weight of the products 16 housed in the container 14 acting on the access panel 40. Several examples of techniques that may be used to weaken the first and second severance lines 46, 48 include forming perforations in the container 14 along the first and second severance lines 46, 48, scoring the container 14 and forming creases in the container 14.

The forward edge 42 may laterally extend across the base wall 34 of the container 14 from proximate the right side wall 30 to proximate the left side wall 32. The forward edge 42 may be positioned proximate the intersection 54 of the base wall 34 with the front wall 26 of the container 14.

In a first implementation, the forward edge 42 may be a free edge (i.e., not connected to adjacent structure). For example, the forward edge 42 may extend along the intersection 54, and the base wall 34 may not be connected to the front wall 26 along the intersection 54.

In a second implementation, the forward edge 42 may be defined by a severance line that must be severed to free the forward edge 42. In a first expression of the second implementation, the forward edge 42 may be freed by severing the severance line defining the forward edge 42 prior to loading the container 14 onto the dispenser 12. For example, the forward edge 42 may be freed by pulling a zipper strip from the container 14 prior to loading the container 14 onto the dispenser 12. In a second expression of the second implementation, the forward edge 42 may be freed by severing the severance line defining the forward edge 42 as the container 14 is being loaded onto the dispenser 12.

As shown in FIG. 4, when the forward edge 42 is free and the first and second severance lines 46, 48 have been severed, the access panel 40 may pivot relative to the base wall 34 about the pre-formed pivot line 44 to form an opening 56. The opening 56 may be of a sufficient size and shape to allow products 16 (FIG. 6) to pass therethrough.

In one implementation, the first and second severance lines 46, 48 may be severed to release the access panel 40 as the container 14 is loaded onto the dispenser 12, as described in greater detail herein. In another implementation, the first and second severance lines 46, 48 may be severed to release the access panel 40 prior to loading the container 14 onto the dispenser 12, such as by manually severing the first and second severance lines 46, 48 (e.g., with a knife or box cutter).

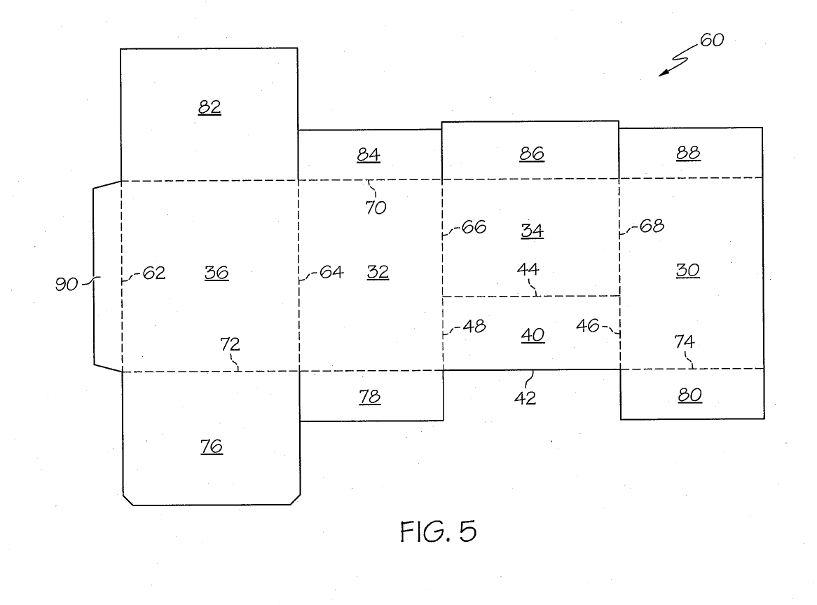

The container 14 may be formed from a paperboard container blank, such as the paperboard container blank 60 shown in FIG. 5. The container blank 60 may include a plurality of pre-formed fold lines 62, 64, 66, 68, 70, 72, 74 that define the front wall 26 (comprised of front wall panels 76, 78, 80), the rear wall 28 (comprised or rear wall panels 82, 84, 86, 88), the right side wall 30, the left side wall 32, the base wall 34, the upper wall 36 and a sealing flap 90.

The container 14 may be assembled by folding the container blank 60 along the longitudinal fold lines 62, 64, 66, 68 and connecting the sealing flap 90 to the right side wall 30 to form the three-dimensional body of the container 14. Then, the front wall panels 76, 78, 80 may be assembled to form the front wall 26 of the container 14. Finally, the rear wall panels 82, 84, 86, 88 may be assembled to form the rear wall 28 of the container 14.

While a specific paperboard container blank 60 is shown and described, those skilled in the art will appreciate that various techniques and materials may be used to form the container 14. Folded paperboard containers are only one specific and non-limiting example of the disclosed container 14.

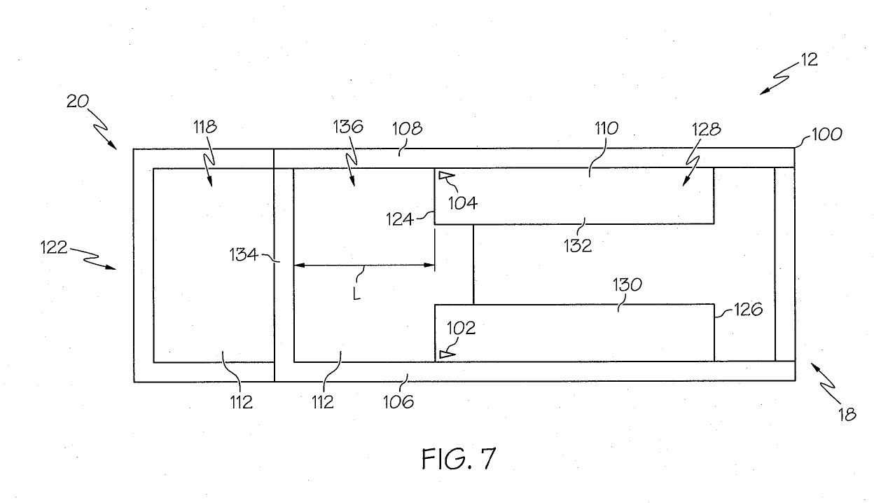

Referring to FIGS. 6 and 7, the dispenser 12 may include a frame 100 and one or more opening tools 102, 104. The frame 100 of the dispenser 12 may support the container 14 in a desired configuration. The opening tools 102, 104 may sever the first and second severance lines 46, 48 (FIG. 2) to release the access door 40 and form the opening 56 (FIG. 4) in the container 14 as the container 14 is loaded onto the frame 100, thereby releasing the products 16 from the container 14 to the dispenser 12.

The frame 100 may include a first (e.g., right) side wall 106, a second (e.g., left) side wall 108, an upper support deck 110 and a lower support deck 112. The right side wall 106 may be laterally spaced from the left side wall 108, and may be generally parallel with the left side wall 108.

The lower support deck 112 may laterally extend between the right and left side walls 106, 108, and may include a front end 114 that longitudinally extends toward the front end 20 of the frame 100 and a rear end 116 that longitudinally extends toward the rear end 18 of the frame 100. Therefore, the lower support deck 112 and the side walls 106, 108 may define a lower level 118 of the frame 100.

The lower support deck 112 may be inclined from the front end 114 to the rear end 116 (i.e., the rear end 116 may be elevated relative to the front end 114) such that products 16 deposited proximate the rear end 116 of the lower support deck 112 roll down to the front end 114 of the lower support deck 112 under the force of gravity. The extent of the incline of the lower support deck 112 may be dictated by, among other things, the coefficient of friction of the material used to form the frame 100 and the shape of the products 16 to be dispensed by the dispenser 12.

A stop 120 may be positioned proximate the front end 114 of the lower support deck 112 to prevent products 16 from rolling beyond the front end 114 of the lower support deck 112. For example, the stop 120 may be connected to (e.g., integral with) the lower support deck 112, and may form an upward curve at the front end 114 of the lower support deck 112. Therefore, the stop 120 may collect products 16 at the front end 114 of the lower support deck 112, thereby defining a product display area 122 at the front end 114 of the lower support deck 112.

While the dispenser 12 is shown dispensing a single lane of products 16 (see FIG. 1), those skilled in the art will appreciate that the frame 100 of the dispenser 12 may be constructed to accommodate two or more lanes of product 16 without departing from the scope of the present disclosure.

The upper support deck 110 may laterally extend between the right and left side walls 106, 108, and may include a front end 124 that longitudinally extends toward the front end 20 of the frame 100 and a rear end 126 that longitudinally extends toward the rear end 18 of the frame 100. Therefore, the upper support deck 110 and the side walls 106, 108 may define an upper level 128 of the frame 100.

As shown in FIG. 7, in one particular construction, the upper support deck 110 may be comprised of two spaced rails 130, 132. The first rail 130 may be connected to the right side wall 106 and the second rail 132 may be connected to the left side wall 108.

A stop 134 may be supported in the upper level 128 of the frame 100 proximate the front end 20 of the frame 100. The stop 134 may be positioned to inhibit forward movement of the container 14 beyond the stop 134 as the container 14 is urged toward the stop 134 along the upper support deck 110.

The stop 134 may be spaced from the front end 124 of the upper support deck 110 to define an opening 136 therebetween. The opening 136 may have a longitudinal length L that is substantially equal to or greater than the distance D between the pre-formed pivot line 44 and the forward edge 42 of the access panel 40. Therefore, the opening 136 may function as a transition or chute through which products 16 exiting the container 14 may pass as the products 16 move from the upper level 128 to the lower level 118 of the frame 100.

The upper support deck 110 may be inclined from the front end 124 to the rear end 126 (i.e., the rear end 126 may be elevated relative to the front end 124). Therefore, products 16 supported by the upper support deck 110 may roll under the force of gravity down to the front end 124 of the upper support deck 110, through the opening 136 in the frame 100, to the lower level 118 of the frame 100 and, ultimately, to the product display area 122.

The opening tools 102, 104 may be positioned in the upper level 128 of the frame 100 to sever the first and second severance lines 46, 48 (FIG. 2), respectively, of the container 14 as the container 14 is urged along the upper support deck 110 of the frame 100. The type of opening tools 102, 104 used, as well as the position of the opening tools 102, 104 relative to the frame 100, may depend on the configuration of the access panel 40 of the container 14, among other things.

In one particular construction, the opening tools 102, 104 may be rearwardly protruding cutting elements (e.g., knife blades) positioned proximate the front end 124 of the upper support deck 110. For example, opening tool 102 may be connected to the upper support deck 110 proximate the right side wall 106 of the frame 100 and opening tool 104 may be connected to the upper support deck 110 proximate the left side wall 108 of the frame 100. Therefore, the opening tools 102, 104 may sever the first and second severance lines 46, 48 (FIG. 2) as the container 14 is urged toward the stop 134 along the upper support deck 110 of the frame 100, thereby allowing the access panel 40 to pivot about the pre-formed pivot line 44 to form the opening 56 in the container 14.

At this point, those skilled in the art will appreciate that opening tools 102, 104 are only one specific example of suitable opening tools, and that various alternative opening tools may be used without departing from the scope of the present disclosure. For example, a single opening tool may be used to form two access panels in the container 14 that open laterally outward, as described in U.S. patent application Ser. No. 12/777,444 (discussed above).

Accordingly, the disclosed rear-loading product dispensing system 10 may be assembled to dispense products 16 by positioning the container 14 onto the rear end 126 of the upper support deck 110 of the frame 100 and urging the container 14 forward (i.e., toward the stop 134) along the upper support deck 110. As the container moves relative to the opening tools 102, 104, the opening tools 102, 104 may sever the first and second severance lines 46, 48, thereby allowing the access panel 40 to pivot relative to the base wall 34 about the pre-formed pivot line 44. As the container 14 continues to move forward, the access panel 40 may drop through the opening 136 in the frame 100 to form the opening 56 in the container 14, as shown in FIG. 6, thereby allowing the products 16 in the container 14 to exit the container 14 through the opening 56 and move to the lower level 118 of the frame 100 and, ultimately, to the product display area 122.

Although various aspects of the disclosed rear-loading product dispensing system and method have been shown and described, modifications may occur to those skilled in the art upon reading the specification. The present application includes such modifications and is limited only by the scope of the claims.

What is claimed is:

1. A product dispensing system comprising:
a container;
a plurality of products initially housed in said container; and
a dispenser comprising:
a frame having a front end and a rear end, said frame comprising a support deck and a product display area, said support deck extending between said front end and said rear end of said frame, said product display area being positioned below said support deck proximate said front end of said frame; and
an opening tool positioned to open said container and allow at least one product of said plurality of products to move from said container to said product display area as said container is moved along said support deck from said rear end toward said front end.

2. The product dispensing system of claim 1 wherein said container comprises paperboard.

3. The product dispensing system of claim 1 wherein said container is a generally rectilinear container.

4. The product dispensing system of claim 1 wherein said container defines at least one access panel, and wherein said access panel is opened by said opening tool as said container is moved along said support deck from said rear end toward said front end.

5. The product dispensing system of claim 4 wherein said access panel is at least partially defined by at least one severance line, said severance line being severed by said opening tool as said container is moved along said support deck from said rear end toward said front end.

6. The product dispensing system of claim 5 wherein said access panel is further defined by a pre-formed pivot line, and wherein said access panel pivots about said pre-formed pivot line when said severance line is severed by said opening tool.

7. The product dispensing system of claim 5 wherein said severance line comprises perforations.

8. The product dispensing system of claim 5 wherein said severance line is defined by a score in said container.

9. The product dispensing system of claim 1 wherein said frame further comprises a first side wall and a second side wall, and wherein said support deck extends between said first side wall and said second side wall.

10. The product dispensing system of claim 1 wherein said frame further comprises a lower support deck extending between said front end and said rear end of said frame, said lower support deck being positioned below said support deck and comprising a front end and a rear end, said front end of said lower support deck defining said product display area.

11. The product dispensing system of claim 10 wherein said rear end of said lower support deck is elevated relative to said front end of said lower support deck.

12. The product dispensing system of claim 1 wherein said support deck comprises a front end and a rear end, and wherein said rear end of said support deck is elevated relative to said front end of said support deck.

13. The product dispensing system of claim 12 wherein said frame further comprises a stop positioned proximate said front end of said frame, said stop being spaced from said front end of said support deck to define an opening between said stop and said support deck.

14. The product dispensing system of claim 13 wherein said products have a diameter and said opening has a longitudinal length, said longitudinal length being greater than said diameter.

15. The product dispensing system of claim 12 wherein said opening tool is positioned proximate said front end of said support deck.

16. The product dispensing system of claim 1 wherein said opening tool comprises a cutting edge that protrudes toward said rear end of said frame.

17. The product dispensing system of claim 1 wherein said opening tool is connected to said support deck.

18. The product dispensing system of claim 1 wherein said dispenser further comprises a second opening tool, said second opening tool being positioned to open said container as said container is moved along said support deck from said rear end toward said front end.

19. A product dispensing system comprising:
a container comprising a plurality of walls that define an internal volume, at least one wall of said plurality of walls comprising a pre-formed pivot line and a severance line that at least partially define an access panel;
a plurality of products initially received in said internal volume; and
a dispenser comprising:
a frame having a front end and a rear end, said frame comprising a support deck and a product display area, said support deck extending between said front end and said rear end of said frame, said product display area being positioned below said support deck proximate said front end of said frame; and
an opening tool positioned to sever said severance line as said container is moved along said support deck from said rear end toward said front end so as to allow said access panel to pivot about said pre-formed pivot line and release at least one product of said plurality of products from said container to said product display area.

20. A method for dispensing comprising the steps of:
providing a container housing a plurality of products, said container comprising a severance line and a pre-formed pivot line that at least partially define an access panel;
providing a dispenser frame having a front end and a rear end, said dispenser frame comprising a support deck and a product display area, said support deck extending between said front end and said rear end of said frame, said product display area being positioned below said support deck proximate said front end of said frame;
providing an opening tool associated with said dispenser frame; and
sliding said container relative to said opening tool along said support deck from said rear end to said front end such that said opening tool severs said severance line to allow said access panel to pivot about said pre-formed pivot line and allow at least one product of said plurality of products to be dispensed from said container to said product display area.
